(19) United States
(12) Patent Application Publication
(10) Pub. No.: US 2004/0008296 A1
(43) Pub. Date: Jan. 15, 2004

(54) Quasi color LCD

(75) Inventors: Kenneth Vi Ung, Phoenix, AZ (US); Mahyar Vahabzadeh-Hagh, Phoenix, AZ (US); Harold Gee Yee, Chandler, AZ (US); Robert Gary Minnick, Chandler, AZ (US); Walter J. Paciorek, Phoenix, AZ (US)

Correspondence Address: Paul F. Wille, Durel Corporation, 2225 West Chandler Blvd., Chandler, AZ, 85224, US

(73) Assignee: Durel Corporation

(21) Appl. No.: 10/194,194

(22) Filed: Jul. 12, 2002

(51) Int. Cl. G02F 1/1335

(52) U.S. Cl. 349/61

(57) ABSTRACT

A light source and a liquid crystal display are separated by a transparent, color graphic to simulate a color liquid crystal display. The light source preferably produces a substantially white light, as is available by cascading materials, and includes discrete or diffuse sources. The liquid crystal display is preferably positive (black on white) rather than negative to reveal more of the graphic. With an EL light source, the graphic can be printed on the transparent substrate of the EL lamp. In liquid crystal displays having a transflective layer, the transflective layer can be located between the light source and the graphic layer.

### BACKGROUND OF THE INVENTION

This invention relates to liquid crystal displays (LCDs) and, in particular, to a monochromatic LCD having the appearance of being a color display.

Liquid crystal displays are the display of choice in hand held devices, such as cellular telephones, global position sensors, personal digital assistants, and in many other applications that are not hand held, e.g. appliance displays and office machines. Most liquid crystal displays include some means for backlighting the display for use in subdued lighting. Typically, light emitting diodes and some sort of diffuser or an electroluminescent (EL) lamp is used as the source of back lighting. Other sources of light can be used, such as cold cathode fluorescent lamps, but these other sources are typically much more expensive than LEDs or EL lamps.

Light sources for backlighting displays and other applications often require a relatively full color spectrum. Incandescent lamps have a broad emission spectrum but tend to be reddish, consume too much power, and generate too much heat for most applications. Electroluminescent (EL) lamps rely on the emission of light from phosphors, which generally have a limited spectrum with pronounced peaks. Phosphors emitting different colors can be mixed and cascading dye added, wherein the dye converts light from one phosphor into light of a longer wavelength. Most light emitting diodes produce a very narrow spectrum of light but come in a variety of colors and can be quite bright in small sizes, as desired in displays for hand-held devices.

Color liquid crystal displays are expensive and typically include a matrix of cells forming the display, wherein the cells transmit light of one color or another to make up the display. Despite its attractiveness, color is rarely necessary for representing information graphically. On the other hand, the markets for watches, cellphones, and other portable electronic devices are ruled by appearance rather than necessity. It would give one an extremely high cost advantage to have the appearance of a color LCD without the expense of actually providing a color LCD.

It is known in the art to provide a translucent film between an LCD and an EL lamp; see U.S. Pat. No. 4,580,877 (Washo). Such film is for scattering light, not forming an image. It is known in the art to provide graphics on a backlit layer, as disclosed in U.S. Pat. No. 4,775,964 (Alessio et al.). It is known in the art to provide a removable graphic over a watch face; e.g., U.S. Pat. No. 5,224,078 (Mallin). It is also known to print indicia on the outer surface of the substrate of an EL lamp and to have a graphic substantially disappear when the lamp is turned off; see U.S. Pat. No. 5,734,627 (Sy).

In view of the foregoing, it is therefore an object of the invention to provide a color graphic for a monochromatic liquid crystal display.

Another object of the invention is to reduce the cost of what appears to be a color liquid crystal display.

### SUMMARY OF THE INVENTION

The foregoing objects are achieved in this invention wherein a light source and a liquid crystal display are separated by a color graphic to simulate a color liquid crystal display. The light source preferably produces a substantially white light, as is available by cascading materials, and includes discrete or diffuse light sources. The liquid crystal display is preferably positive (dark on light) rather than negative to reveal more of the graphic. With an EL light source, the graphic can be printed on the transparent substrate of the EL lamp. In liquid crystal displays having a transflective layer, the transflective layer can be located between the light source and the graphic layer.

### BRIEF DESCRIPTION OF THE DRAWINGS

A more complete understanding of the invention can be obtained by considering the following detailed description in conjunction with the accompanying drawings, in which:

FIG. 1 is cross-section of a display constructed in accordance with the invention;

FIG. 2 is cross-section of a display constructed in accordance with the invention using a discrete light source;

FIG. 3 is cross-section of a display constructed in accordance with a preferred embodiment of the invention using a diffuse light source;

FIG. 4 is a cross-section of a display constructed in accordance with an alternative embodiment of the invention;

FIG. 5 is a cross-section of a display constructed in accordance with another aspect of the invention; and

FIG. 6 is a three-quarter view of a cellphone having a display constructed in accordance with the invention.

### DETAILED DESCRIPTION OF THE INVENTION

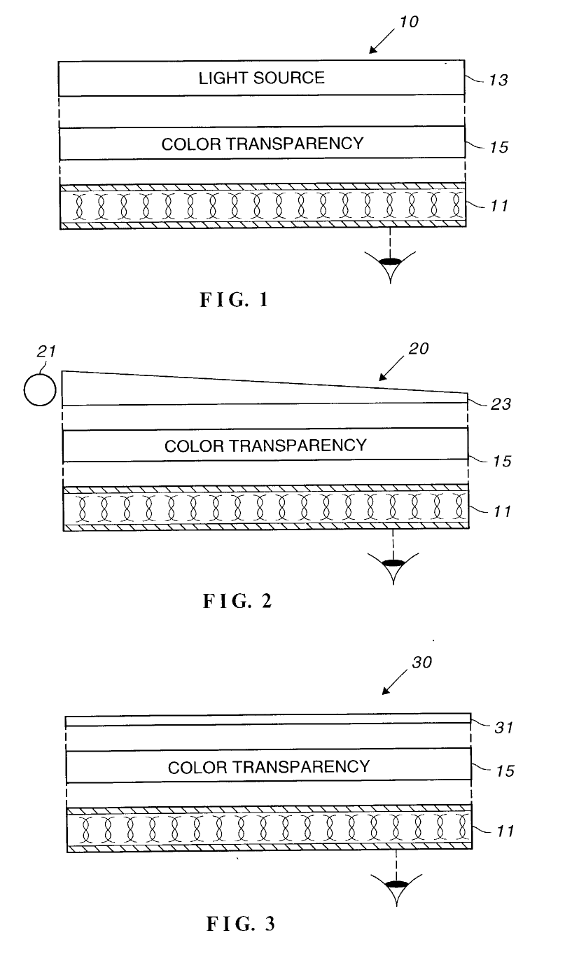

In FIG. 1, display 10 includes liquid crystal 11 and light source 13 for backlighting liquid crystal 11 during subdued ambient light and for reflecting ambient light back through liquid crystal 11 under bright ambient light, such outdoors during daytime or indoors in an office or store.

Positioned between liquid crystal 11 and light source 13 is color transparency 15. Transparency 15 can include any desired graphic or image, such as a photograph of a person, place, or thing, or a corporate logo. Preferably, light source 13 provides a sufficiently white light for producing a realistic or pleasant appearance in the transparency and need not be a “true” white, as determined from a chromaticity diagram. Suitable light sources are known in the art.

In FIG. 2, the light source for display 20 includes lamp 21 and wedge 23 for diffusing or spreading the light over the area of the display. Lamp 21 is a discrete or localized light source in the sense that the useful luminous surface of the lamp is substantially less than the visible area of the liquid crystal. A light emitting diode and a cold cathode lamp are examples of such lamps. Transparency 15 and liquid crystal 11 are the same as in FIG. 1.

In FIG. 3, the light source for display 30 includes electroluminescent lamp 31. Lamp 31 is a diffused light source in the sense that the useful luminous surface of the lamp is substantially equal to the visible area of the liquid crystal. Transparency 15 and liquid crystal 11 are the same as in FIG. 1. The color of the electroluminescent lamp is preferably near white and depends upon the content of the transparency.

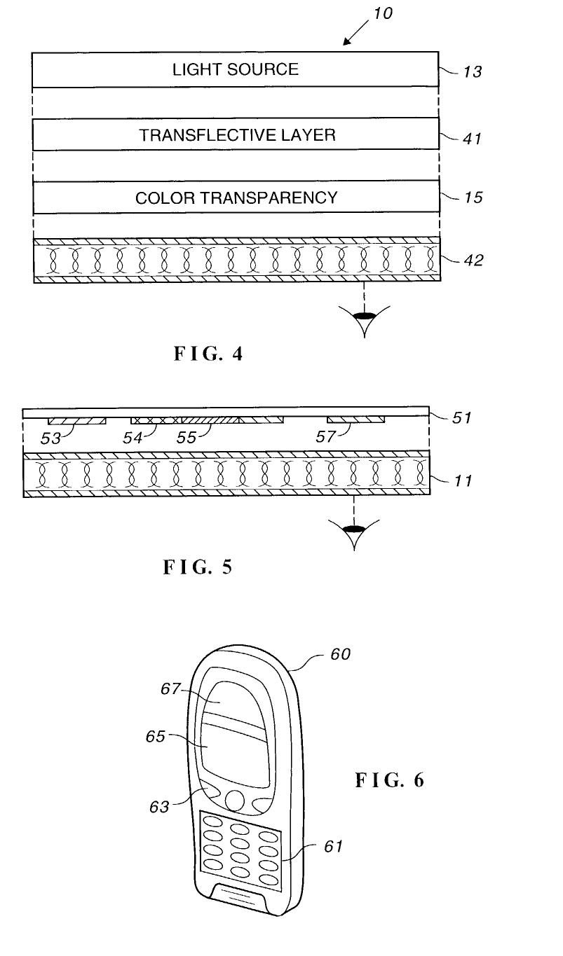

Backlit liquid crystal displays typically include what is known as a “transflective” layer; i.e. a layer that is both transmissive and reflective, between the light source and the liquid crystal material. When transparency 15 is behind the transflective layer, the image is visible only when the light source is turned on. In accordance with another aspect of the invention, the liquid crystal display is modified by placing the transparency in front of the transflective layer, as illustrated in FIG. 4. When transparency 15 is in front of the transflective layer, the image is visible whether or not the light source is turned on.

In FIG. 4, color transparency 15 is placed between transflective layer 41 and liquid crystal element 42. Light source 13 is a light source such as described in connection with FIGS. 2 and 3. In this embodiment, the image on transparency 15 is visible by ambient light or by turning on light source 13.

Color transparency 15 is produced by any suitable means; for example, a photographic image stored on what is known as positive color film for “slides”, stamping or printing color inks on a transparent sheet, or printing an image from a xerographic printer or an ink jet printer on to a transparent sheet. The image can be continuous or half tone, polychromatic or monochromatic, a graphic, a watermark, or a recognizable scene.

An EL lamp includes a relatively thick, e.g. 5-7 mil, transparent substrate of polyester or polycarbonate material on which a very thin, transparent, conductive layer and other layers are deposited. The lamp emits light through the transparent substrate. FIG. 5 illustrates a display constructed in accordance with another aspect of the invention in which an image is printed on the outside of the transparent substrate of an EL lamp. EL lamp 51 is printed as described above and attached to the rear of liquid crystal display 11. Areas 53, 54, 55, and 57 represent areas of different color that have been printed or deposited on the transparent substrate of EL lamp 11. The inks can be translucent or opaque, polychromatic or monochromatic (e.g. black and white or sepia and white).

In FIG. 6, cellphone 60 includes keypad 61 having keys 0-9, * (star), and # (pound), and control keys, such as key 63. Information is displayed in display area 65 and area 67 contains a logo or other graphic. In accordance with the invention, all these areas can be backlit with a single EL panel containing several lamps or by a plurality of lamps, e.g., one lamp for each area or key. A backlit liquid crystal display is in area 65 and a printed lamp alone or a transparency overlying an EL lamp are visible in area 67. A mixture of polychromatic and monochromatic images can be used to provide a visually interesting display or a single image can be displayed across both areas 65 and 67.

The invention thus provides a color graphic for a monochromatic liquid crystal display and substantially reduces the cost of what appears to be a color liquid crystal display.

Having thus described the invention, it will be apparent to those of skill in the art that various modifications can be made within the scope of the invention. For example, the transparency can be removable and interchangeable with other transparencies in a set. The liquid crystal display can be positive or negative, i.e., dark on light (clear) or light on dark. Positive is preferred. Although a plurality of lamps may be included in a single panel, the invention does not relate to active matrix EL devices, which include hundreds of little EL lamps in an ordered array.

What is claimed as the invention is:

1. In an electronic device having a display including a monochromatic liquid crystal for displaying information and a light source for back lighting the liquid crystal, the improvement comprising:
a transparency interposed between said liquid crystal and said light source, said transparency including an image.

2. The device as set forth in claim 1 wherein said transparency is removable.

3. The device as set forth in claim 1 wherein said light source includes at least one electroluminescent lamp.

4. The device as set forth in claim 3 wherein said transparency includes a transparent layer and a printed layer.

5. The device as set forth in claim 4 wherein said electroluminescent lamp includes a transparent substrate and said transparent layer is said transparent substrate.

6. The device as set forth in claim 1 wherein said transparency includes photographic film.

7. The device as set forth in claim 1 wherein said transparency includes a transparent substrate and a printed layer.

8. The device as set forth in claim 1 wherein said liquid crystal includes a transflective layer and said transflective layer is located between said light source and said transparency.

9. The device as set forth in claim 8 wherein said light source includes at least one electroluminescent lamp.

10. A display comprising:
a monochromatic liquid crystal for displaying information;
a light source for back lighting the liquid crystal;
a transparency interposed between said liquid crystal and said light source, said transparency including an image.

11. The display as set forth in claim 10 wherein said light source includes at least one electroluminescent lamp.

12. The display as set forth in claim 10 wherein said light source includes at least one light emitting diode.

13. The display as set forth in claim 10 wherein said light source includes at least one cold cathode fluorescent lamp.

14. A display comprising:
a monochromatic liquid crystal display;
an EL lamp for back lighting the liquid crystal display, wherein said EL lamp includes
a transparent substrate having a first major surface and a second major surface;
a transparent conductive layer on said first major surface; and
a graphic printed on said second major surface.

15. The EL lamp as set forth in claim 14 wherein said graphic is polychromatic.

16. The EL lamp as set forth in claim 14 wherein said graphic is monochromatic.

17. The EL lamp as set forth in claim 14 wherein said graphic is continuous tone.

18. The EL lamp as set forth in claim 14 wherein said graphic is half tone.

19. The EL lamp as set forth in claim 14 wherein said graphic is translucent.

20. The EL lamp as set forth in claim 14 wherein said graphic is opaque.
